(19) United States
(12) Patent Application Publication
(10) Pub. No.: US 2026/0289594 A1
(43) Pub. Date: Sep. 24, 2026

(54) SYSTEMS AND METHODS FOR STOCHASTIC SIMULATION OF SOURCE RESPONSES TO INPUTS IN A RESOURCE EXCHANGE ECOSYSTEM

(71) Applicant: BANK OF AMERICA CORPORATION, Charlotte, NC (US)

(72) Inventors: Ana Maxim, Arlington, VA (US); Scott R. Enscoe, Waxhaw, NC (US); Marshall A. Johnson, Summitt, NJ (US); Kathlyn Rooney, Boston, MA (US); Daniel Wennerstrum, Chicago, IL (US)

(73) Assignee: BANK OF AMERICA CORPORATION, Charlotte, NC (US)

(21) Appl. No.: 19/084,040

(22) Filed: Mar. 19, 2025

(51) Int. Cl. G06Q 30/0202

(52) U.S. Cl. CPC G06Q 30/0202

(57) ABSTRACT

Systems, computer program products, and methods are described herein for stochastic simulation of source responses to inputs in a resource exchange ecosystem. Embodiments of the present disclosure are configured to generate a simulation including a resource exchange ecosystem, where the resource exchange ecosystem includes a plurality of entities, where each entity of the plurality of entities includes a plurality of users and one or more decision makers, receive, via a network interface, a simulation input set associated with the resource exchange ecosystem, adjust the resource exchange ecosystem using the simulation input set, execute the simulation with the adjusted resource exchange ecosystem to generate a simulation result set for the simulation input set, generate an expected outcome using the simulation result set, and transmit, via the network interface, the expected outcome.

### FIELD OF THE INVENTION

The present invention embraces a system for stochastic simulation of source responses to inputs in a resource exchange ecosystem.

### BACKGROUND

Presently, in today's environment, anticipating future patterns or outcomes within an industry is impossible. This is especially true when considering the future sentiments, outputs, and responses across an entire group of entities, which each may include a large number of users and decision-makers. Therefore, there is a need for systems for analyzing sentiments within a large ecosystem of entities, especially when those entities may be competing.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for stochastic simulation of source responses to inputs in a resource exchange ecosystem may include a network interface configured to communicate via a communication network, at least one non-transitory storage device including computer program code stored thereon, and at least one processing device operably coupled to the network interface and the at least one non-transitory storage device. In some embodiments, the computer program code may include computer instructions configured to cause the processing device to generate a simulation including a resource exchange ecosystem, where the resource exchange ecosystem may include a plurality of entities, where each entity of the plurality of entities may include a plurality of users and one or more decision makers, receive, via the network interface, a simulation input set associated with the resource exchange ecosystem, adjust the resource exchange ecosystem using the simulation input set, execute the simulation with the adjusted resource exchange ecosystem to generate a simulation result set for the simulation input set, generate an expected outcome using the simulation result set, and/or transmit, via the network interface, the expected outcome.

In some embodiments, the at least one non-transitory storage device may include computer-executable program code that, when executed by the at least one processing device, causes the at least one processing device to, when executing the simulation, receive, via the network interface, a dataset including a plurality of scenarios, simulate each scenario of the plurality of scenarios to generate, for each scenario, a scenario result, and/or generate the simulation result set using each scenario result. Further, the dataset including the plurality of scenarios may be generated by an artificial intelligence (AI) model configured to randomly select a simulation element of the resource exchange ecosystem, randomly generate one or more inputs to the simulation element, and/or generate a scenario including the simulation element including the generated one or more inputs. Additionally, or alternatively, one or more users of each plurality of users may be associated with one or more additional entities of the plurality of entities.

In some embodiments, a subset of users of a plurality of users of an entity of the plurality of entities may each be associated with a resource account, where each resource account may be generated using an average resource balance and a standard deviation of the average resource balance, and/or where the average resource balance may be generated via data of another subset of users of the plurality of users of the entity. Further, the simulation input set may include a resource associated product and where the at least one non-transitory storage device may include computer-executable program code that, when executed by the at least one processing device, causes the at least one processing device to, when executing the simulation, mature the resource account associated with each user of the subset of users to a target date in an environment including the resource associated product, predict a resource account balance for each resource account at the target date, and predict engagement for each user of the subset of users with the resource associated product at the target date.

In some embodiments, the simulation input set may include a resource associated product associated with a first entity of the plurality of entities, and where the expected outcome may include a response resource associated product associated with a second entity of the plurality of entities. Additionally, or alternatively, the simulation input set may include a target date for the generated expected outcome, and where executing the simulation may include modeling time evolution of one or more parameters associated with the resource exchange ecosystem.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an exemplary distributed computing environment for stochastic simulation of source responses to inputs in a resource exchange ecosystem, in accordance with an embodiment of the disclosure;

FIG. 2 illustrates an exemplary AI engine subsystem architecture, in accordance with an embodiment of the disclosure;

FIG. 3 illustrates an exemplary generative AI subsystem, in accordance with an embodiment of the disclosure;

FIG. 4 illustrates a process flow for stochastic simulation of source responses to inputs in a resource exchange ecosystem, in accordance with an embodiment of the disclosure;

FIG. 5 illustrates another process flow for stochastic simulation of source responses to inputs in a resource exchange ecosystem, in accordance with an embodiment of the disclosure; and

FIG. 6 illustrates another process flow for stochastic simulation of source responses to inputs in a resource exchange ecosystem, in accordance with an embodiment of the disclosure;

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data. Additionally, as used herein, a “subentity” may refer to a smaller, distinct part or group that may be a part of a larger entity. Typically, subentities may operate under the broader entity but may have their own specific functions, responsibilities, and/or goals. Subentities may be typically organized to handle specific tasks or serve particular groups within the larger framework.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, and/or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning of, for example, distal phalanges, intermediate phalanges, proximal phalanges, and/or the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, and/or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, and/or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and/or the like.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository—a storage location where one or more resources are organized, stored and retrieved electronically using a computing device.

As used herein, a “resource transfer,” “resource distribution,” or “resource allocation” may refer to any transaction, activities, and/or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer”, a “transaction”, a “transaction event”, or a “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and/or the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “data element” may refer to a single unit of information and/or of data within a datafile, database, dataset, document, image, PDF, and/or the like. The data element may represent a specific value and/or piece of data that is stored and/or processed. In other words, a data element may represent any individual piece of data within a structured collection of information. For example, in a spreadsheet, a data element may be a value in a single cell. In a database, a data element may be a specific field in a record. In a CSV file, data elements may be separated by commas and may include values such as “Product Name,” “Price,” or “User Address.” In an image, a data element may be a single pixel of the image and/or a collection of pixels representing a section of the image. In a datafile, a data element may be described as a single unit or piece of information that is stored within the datafile. The data element may represent a specific attribute or value related to the datafile's overall purpose. Each data element may be structured to hold a particular type of information (e.g., a number, text, a date, code, and/or the like). These elements are the building blocks of the datafile, working together to form a complete set of information that can be processed, analyzed, or stored.

As used herein, the terms “random,” “probabilistic,” “stochastic,” and similar terms generally refer to processes or systems where outcomes or events may be influenced by chance, uncertainty, and/or a set of probabilistic rules. These processes may be described by mathematical models that represent uncertainty or variability in outcomes, typically involving random variables and/or distributions. In some contexts, random and probabilistic processes may be used to model phenomena such as interaction patterns, resource market fluctuations, resource values, and/or the behavior of entities and/or users. A stochastic system, for example, may be one where a future state may be determined not solely by past states but also by some inherent randomness. For purposes of the present disclosure, these terms may describe systems, processes, parameters, elements, and/or methods that may be analyzed, modeled, and/or simulated using statistical and computational methods to predict and/or understand behavior over time. In some embodiments described herein, these words may be used interchangeably with one another.

The present disclosure may include a system, computer program, and/or method for stochastic simulation of source responses to inputs in a resource exchange ecosystem. Presently, in today's environment, anticipating future patterns or outcomes within an industry is impossible. This is especially true when considering the future sentiments, outputs, and responses across an entire group of entities, which each may include a large number of users and decision-makers. Therefore, there is a need for systems for analyzing sentiments within a large ecosystem of entities, especially when those entities may be competing.

In today's environment, anticipating future patterns and/or outcomes within an industry is impossible. Thus, the invention provides a system for analyzing sentiments within a large network of entities, especially when those entities are competing. Such a system may include a plurality of formations across an ecosystem of these entities, such that a plurality of simulations may be run across the ecosystem. In this manner, the system may be used to analyze the sentiments or outputs from these entities on both a micro and a macro level (e.g., entity-specific or ecosystem-wide specific).

Further, and in some embodiments, potential products may be tested using this ecosystem. In some such embodiments, the products may be updated after running the scenario in the ecosystem. In some embodiments, the system may include a plurality of levers or switches using AI injectors to change inputs to the ecosystem slightly or majorly. Based on these inputs applied to the ecosystem, the system may determine optimal strategies to improve over other entities in the ecosystem. Some of these levers may include broad user or client factors that may be changed and tracked over time to determine how users may interact with the entities in different scenarios. Additionally, or alternatively, these factors may be futuristically simulated for future determinations. Additionally, and in some embodiments, the system may include a temporal indicator showing the time one or more entities may take to reach an output.

Accordingly, embodiments of the present disclosure may be configured to generate a simulation (e.g., a plurality of scenarios for a situation and/or product with each having a random element of the resource exchange ecosystem varied) including a resource exchange ecosystem (e.g., a system of entities, the users associated with one or more of the entities, and any other parties of interest), where the resource exchange ecosystem may include a plurality of entities, where each entity of the plurality of entities may include a plurality of users and one or more decision makers, receive, via a network interface, a simulation input set (e.g., the situation and/or product to be tested) associated with the resource exchange ecosystem, adjust the resource exchange ecosystem using the simulation input set, execute the simulation with the adjusted resource exchange ecosystem to generate a simulation result set for the simulation input set, generate an expected outcome (e.g., the common, average, and/or most frequent result from the simulation) using the simulation result set, and transmit, via the network interface, the expected outcome.

Additionally, embodiments of the present disclosure may, when executing the simulation, receive, via the network interface, a dataset including a plurality of scenarios, simulate each scenario of the plurality of scenarios to generate, for each scenario, a scenario result, and generate the simulation result set using each scenario result. Further, the dataset including the plurality of scenarios may be generated by an AI model configured to randomly select a simulation element of the resource exchange ecosystem, randomly generate one or more inputs to the simulation element, and generate a scenario including the simulation element including the generated one or more inputs.

What is more, the present invention provides a technical solution to a technical problem. As described herein, the technical problem includes simulating source responses (e.g., user responses, entity responses, and/or the like) to inputs in a resource exchange ecosystem. The technical solution presented herein allows for a system to generate a simulation, receive a simulation input set, adjust a resource exchange ecosystem using the simulation input set, execute the simulation, generate an expected outcome, and transmit the expected outcome. In particular, stochastic simulation of source responses to inputs in a resource exchange ecosystem is an improvement over existing solutions to simulating source responses to inputs in a resource exchange ecosystem, (i) with fewer steps to achieve the solution, thus reducing the amount of computing resources, such as processing resources, storage resources, network resources, and/or the like, that are being used (e.g., by simulating a resource exchange ecosystem, macro scale outcomes and/or sentiments and micro scale outcomes and/or sentiments for entities and/or users included in the resource exchange ecosystem may be simultaneously generated reducing the number of additional simulations and/or computational resources required to produce similar results), (ii) providing a more accurate solution to the problem, thus reducing the number of resources required to remedy any errors made due to a less accurate solution (e.g., by simulating a resource associated product with an AI injecting randomness into random elements of the simulation over a plurality of iterations, a vast range of possibilities may be simulated and an average and/or most probabilistic output and/or outcome may be predicted), (iii) removing manual input and waste from the implementation of the solution, thus improving speed and efficiency of the process and conserving computing resources (e.g., by using AI in conjunction with simulations, adjustments to an iteration of a simulation may be generated and included automatically and the predicted outcome based on all iterations may be automatically generated thus reducing manual input and waste), and (iv) determining an optimal amount of resources that need to be used to implement the solution, thus reducing network traffic and load on existing computing resources (e.g., by using AI and/or additional real world data in conjunction with simulations, the required number of randomized iterations for a simulation to accurately predict an outcome may be determined reducing the number of iterations performed). Furthermore, the technical solution described herein uses a rigorous, computerized process to perform specific tasks and/or activities that were not previously performed. In specific implementations, the technical solution bypasses a series of steps previously implemented, thus further conserving computing resources.

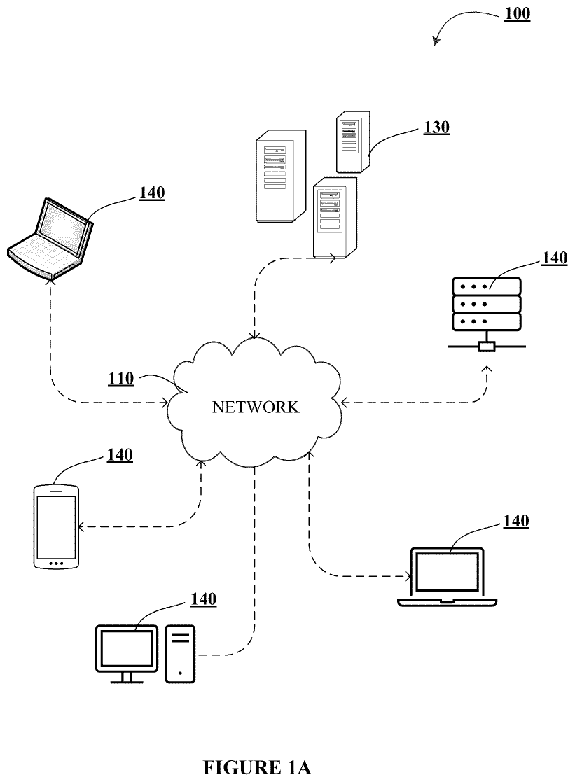

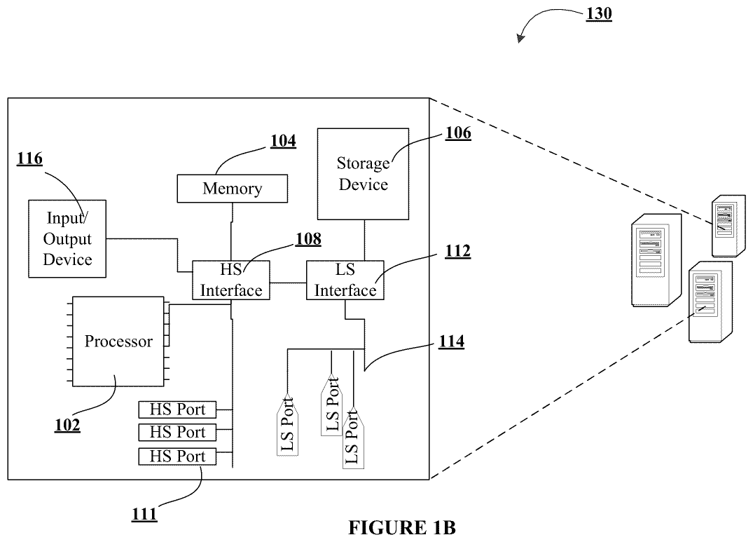

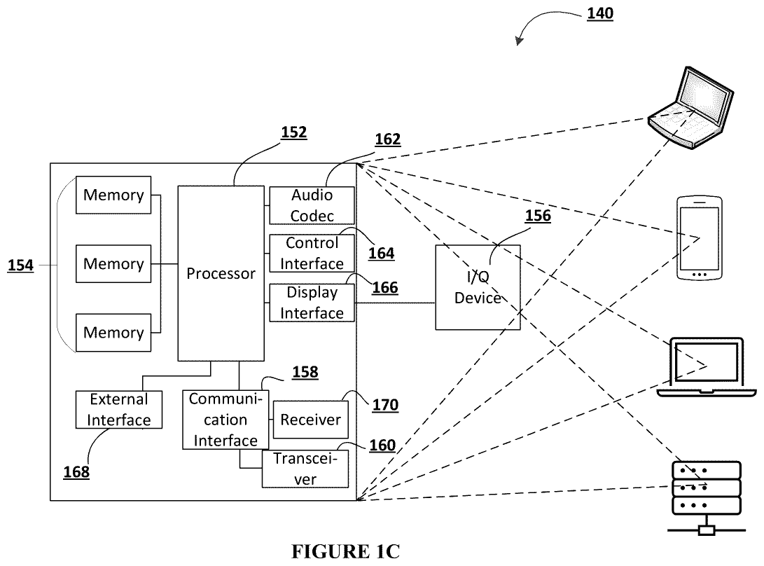

FIGS. 1A-1C illustrate technical components of an exemplary distributed computing environment 100 for stochastic simulation of source responses to inputs in a resource exchange ecosystem, in accordance with an embodiment of the invention. As shown in FIG. 1A, the distributed computing environment 100 contemplated herein may include a system 130 (i.e., a system for stochastic simulation of source responses to inputs in a resource exchange ecosystem), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

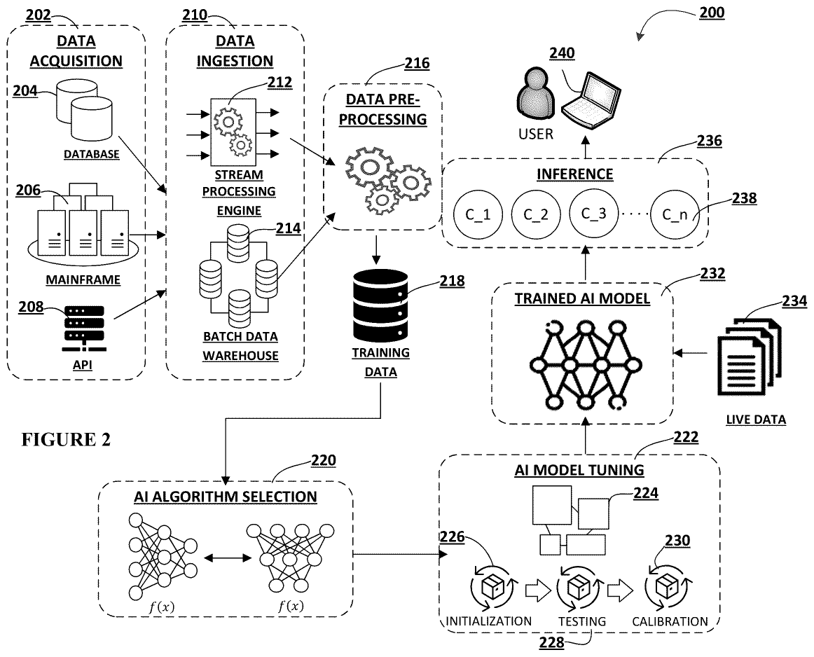

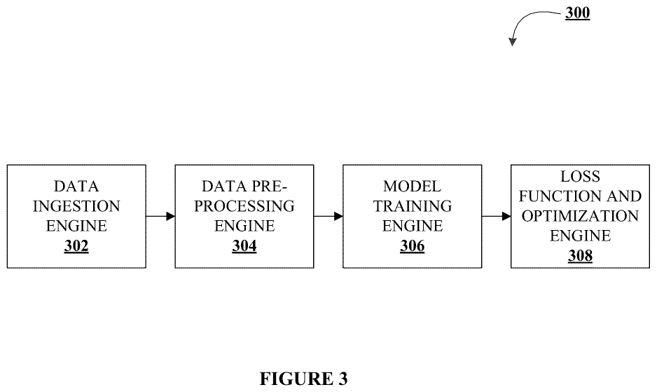

FIG. 2 illustrates an exemplary artificial intelligence (AI) engine subsystem architecture 200, in accordance with an embodiment of the disclosure. In some embodiments, the AI engine subsystem 200 may be included in a system (e.g., similar to the system 130 shown and described herein with respect to FIGS. 1A-1C). Additionally, or alternatively, the AI engine subsystem 200 may be a subsystem of another system (e.g., similar to the system 130 shown and described herein with respect to FIGS. 1A-1C) that is in communication with a system for stochastic simulation of source responses to inputs in a resource exchange ecosystem (e.g., via a network similar to the network 110 as shown and described herein with respect to FIGS. 1A-1C). Further, the AI engine subsystem 200 may be a subsystem of another system (e.g., similar to the system 130 shown and described herein with respect to FIGS. 1A-1C) that is in communication with (e.g., via a network similar to the network 110 as shown and described herein with respect to FIGS. 1A-1C) a generative AI subsystem (e.g., similar to the generative AI subsystem 300 as shown and described herein with respect to FIG. 3). The AI engine subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 210, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the AI engine subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 240. In still other cases, artificial intelligence engines that perform regression techniques may use live data 234 to predict or forecast continuous outcomes.

It will be understood that the embodiment of the AI engine subsystem 200 illustrated in FIG. 2 is exemplary and that other embodiments may vary. As another example, in some embodiments, the AI engine subsystem 200 may include more, fewer, or different components.

FIG. 3 illustrates an exemplary generative AI subsystem 300, in accordance with an embodiment of the invention. In some embodiments, the generative AI subsystem 300 may be included in a system (e.g., similar to the system 130 shown and described herein with respect to FIGS. 1A-1C). Additionally, or alternatively, the generative AI subsystem 300 may be a subsystem of another system (e.g., similar to the system 130 shown and described herein with respect to FIGS. 1A-1C) that is in communication with a system for stochastic simulation of source responses to inputs in a resource exchange ecosystem (e.g., via a network similar to the network 110 as shown and described herein with respect to FIGS. 1A-1C). Further, the generative AI subsystem 300 may be a subsystem of another system (e.g., similar to the system 130 shown and described herein with respect to FIGS. 1A-1C) that is in communication with (e.g., via a network similar to the network 110 as shown and described herein with respect to FIGS. 1A-1C) an AI engine subsystem (e.g., similar to the AI engine subsystem 200 as shown and described herein with respect to FIG. 2).

The generative AI subsystem 300 may include a data ingestion engine 302, a data pre-processing engine 304, a model training engine 306, and a loss function and optimization engine 308. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, and/or from streams. For a large language model (“LLM”), text data may originate from sources such as web scrapes, social media, large public text datasets, and/or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, and/or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training engine 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float33) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

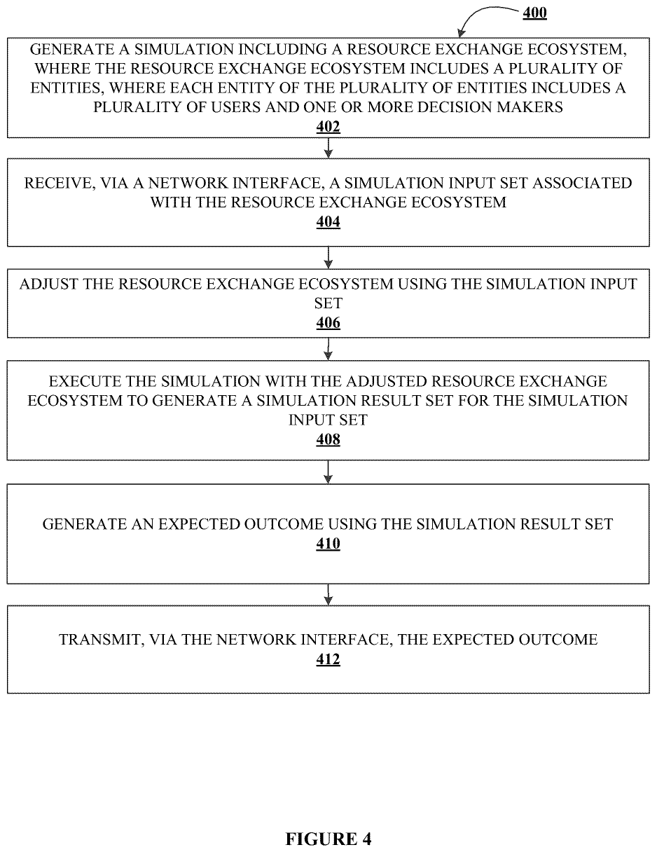

FIG. 4 illustrates a process flow 400 for stochastic simulation of source responses to inputs in a resource exchange ecosystem, in accordance with an embodiment of the disclosure. In some embodiments, a system (e.g., similar to one or more of the systems shown and described herein with respect to FIGS. 1A-1C) may perform one or more of the steps of the process flow 400. For example, a system for stochastic simulation of source responses to inputs in a resource exchange ecosystem (e.g., similar to the system 130 shown and described herein with respect to FIG. 1A-1C) may perform one or more of the steps of the process flow 400. In some embodiments, an artificial intelligence engine (e.g., similar to the AI engine subsystem 200 as shown and described herein with respect to FIG. 2) may perform one or more of the steps of the process flow 400. Additionally, or alternatively, a generative artificial intelligence engine (e.g., similar to the generative AI subsystem 300 as shown and described herein with respect to FIG. 3) may perform one or more of the steps of the process flow 400.

In some embodiments, and as shown in block 402, the process flow 400 may include the step of generating a simulation including a resource exchange ecosystem, where the resource exchange ecosystem includes a plurality of entities, where each entity of the plurality of entities includes a plurality of users and one or more decision makers. In such embodiments, the resource exchange ecosystem may be an environment of competing and/or noncompeting entities (e.g., an institution, group, association, financial institution, establishment, company, union, authority, vendor, and/or the like) each of which may include one or more decision makers (e.g., a person or a group of persons responsible for making decisions within the entity). Further, the resource exchange ecosystem may include a plurality of users, where users of the plurality of users may be associated with one or more of the plurality of entities (e.g., as an employee, a user of a product associated with the entity, and/or the like) such that each entity may include a subset of the plurality of users within the resource exchange network. In this way, each entity of the plurality of entities may each include a plurality of users, some of whom may belong to one or more additional pluralities of users.

In some embodiments, the simulation may be directed to evaluating a resource associated product (e.g., resource exchange device, resource account, physical product, digital product, and/or the like), situation, problem, and/or the like within the resource exchange network to predict a range of potential outcomes and/or a most probabilistic outcome. For example, outputs of a simulation may include user responses and/or sentiments to a resource associated product, other entity responses to a resource associated product offered by an entity (e.g., the other entities may develop new resource associated products of their own in response), and/or the like.

As will be understood by one of ordinary skill in the art in view of the present disclosure, simulations may include one or more of known computational techniques to evaluate a scenario and provide and output. For example, one type of simulation contemplated by the present disclosure may include a Monte Carlo simulation that uses repeated random sampling to estimate the behavior of users and/or entities in the resource exchange ecosystem under uncertainty, where the simulation of the resource exchange ecosystem may be influenced by random variables and/or random parameters. In such simulations, multiple iterations are performed, with each iteration introducing randomness in one or more key parameters that may be randomly chosen for each iteration. By running numerous simulations, the technique helps understand the range of possible outcomes and their likelihoods. A non-exhaustive list of additional computation and/or numerical techniques employed by simulations of the present disclosure may include bootstrap resampling (e.g., a technique with repeated sampling from data with replacement to estimate the distribution of a statistic), Markov Chain Monte Carlo (e.g., a technique that uses Markov chains to sample from complex probability distributions), agent-based modeling (e.g., a technique that simulates interactions of individual agents to explore emergent behavior in complex systems), finite element analysis (e.g., a technique used to model systems by breaking them down into smaller elements), differential equation solvers (e.g., a technique used to simulate dynamic systems over time), genetic algorithms (e.g., a technique that applies principles of natural selection to optimize solutions to complex systems), quasi-Monte Carlo methods (e.g., a technique that aims to improve the efficiency of standard Monte Carlo simulations by using low-discrepancy sequences instead of random sampling), and/or the like.

In some embodiments, an iteration of a simulation may have randomness incorporated by sampling values from predefined probability distributions for one or more parameters used in simulating the resource exchange ecosystem. A non-exhaustive list of probability distributions may include normal distribution (e.g., a symmetric, bell-shaped distribution characterized by its mean and standard deviation), uniform distribution (e.g., a distribution where all outcomes are equally likely within a specified range), binomial distribution (e.g., describes the number of successes in a fixed number of independent Bernoulli trials with a constant probability of success), Poisson distribution (e.g., models the number of events that occur in a fixed interval of time or space, with a known constant mean rate), exponential distribution (e.g., describes the time between events in a Poisson process, representing the time until the next event occurs), gamma distribution (e.g., a two-parameter family of distributions that generalizes the exponential distribution), log-normal distribution (e.g., a distribution of a variable whose logarithm is normally distributed), beta distribution (e.g., a distribution defined on the interval [0, 1]), Weibull distribution (e.g., used in reliability analysis and survival studies, modeling life data or failure times with a shape parameter influencing the failure rate), chi-square distribution (e.g., a distribution of the sum of the squares of independent standard normal random variables), student's t-distribution (e.g., a distribution used when estimating the mean of a normally distributed population with a small sample size), Bernoulli distribution (e.g., a discrete distribution representing the outcome of a binary event), multinomial distribution (e.g., a generalization of the binomial distribution to more than two outcomes), geometric distribution (e.g., describes the number of trials needed to get the first success in a sequence of independent Bernoulli trials), negative binomial distribution (e.g., similar to the geometric distribution but models the number of trials needed to achieve a fixed number of successes in a series of independent trials), triangular distribution (e.g., a distribution often used in simulation modeling that may be defined by a minimum, maximum, and mode (most likely value), Dirichlet distribution (e.g., a distribution over probability vectors), and/or the like.

Additionally, or alternatively, parameters associated with the simulation of the resource exchange ecosystem may be described deterministically, may be described deterministically in some iterations and described probabilistically in other iterations, may be randomly generated by an AI model using any of the techniques described herein, may be randomly selected by an AI model from a distribution, and/or the like. In some embodiments, the parameters of a simulation may have a predetermined value unless randomly selected (e.g., by an AI model configured to randomly decide an element of the resource exchange ecosystem and, thus, parameters associated with the element to randomize). In such embodiments, the number of elements of the resource exchange ecosystem to randomize may be determined by an AI model.

The simulation approach of embodiments of the present disclosure serves to evaluate and quantify sentiments and responses to inputs into the resource exchange ecosystem and assess the probability of various outcomes. In this way, an entity may predict how competing entities may respond and/or catch up to a potential resource associated product and/or determine if the potential resource associated product is worth time and/or resource investment. As such, embodiments of the present disclosure offer efficient and quick vetting of resource associated products and/or additional ideas. Various types of simulations, as described above, may be employed, independently or in tandem, depending on the problem at hand, including agent-based simulations (e.g., simulations that model individual agents interacting with each other), system dynamics simulations (e.g., simulations that study feedback loops in systems), queuing simulations (e.g., simulations that analyze waiting lines and service processes), and/or the like.

In some embodiments, and as shown in block 404, the process flow 400 may include the step of receiving, via a network interface, a simulation input set associated with the resource exchange ecosystem. In such embodiments, the simulation input set may include the problem, situation, resource associated product, and/or the like to be evaluated during the simulation. Additionally, or alternatively, the simulation input set may include a plurality of problems, situations, resource associated products, and/or the like to be simulated simultaneously in the resource exchange environment to evaluate the influence each may have on one other. In some embodiments, the simulation input set may include additional modifications (e.g., additional elements of the resource exchange ecosystem to include, elements of the resource exchange ecosystem to exclude, and/or the like) to the resource exchange ecosystem to be simulations.

In some embodiments, and as shown in block 406, the process flow 400 may include the step of adjusting the resource exchange ecosystem using the simulation input set. In such embodiments, after receiving the simulation input set, the resource exchange ecosystem may be updated (e.g., one or more parameters and/or weights adjusted, added, and/or removed) to incorporate the contents of the simulation input set. Adjusting the resource exchange ecosystem and the associated simulation based on the simulation input set may include several steps. For example, the data of the simulation input set may be extracted and preprocessed to clean, normalize, and/or engineer features and/or parameters to prepare it for integration in the simulation. Further, the simulation model of the resource exchange ecosystem may be updated by adjusting relevant parameters and feeding the data of the simulation input set into the resource exchange ecosystem.

In some embodiments, and as shown in block 408, the process flow 400 may include the step of executing the simulation with the adjusted resource exchange ecosystem to generate a simulation result set for the simulation input set. In such embodiments, as an iteration of the simulation executes, it may generate outputs and/or outcomes based on the adjusted resource exchange ecosystem. Said outcome may be added as an entry to the simulation result set. Further, the entry of the outcome in the simulation result set may be, in some embodiments, linked to simulation details specific to that iteration of the simulation (e.g., elements of the resource exchange ecosystem randomly chosen by an AI model and randomized values associated with the randomly chosen elements).

In some embodiments, the outcome and/or outputs of the iteration may be evaluated against real-world observations and/or predefined objectives. If discrepancies are found, the model may be refined through various processes such as recalibration, optimization, retraining, and/or the like prior to the next iteration of the simulation. In this way, the simulation may be configured as an iterative feedback loop, where the model is further fine-tuned based on performance metrics or errors identified during the execution of an iteration of the simulation. These observations may be employed by the AI model configured to randomly select elements of the resource exchange ecosystem to add randomness to enhance the selection/randomization process (e.g., observations generated by the previous iteration or iterations may inform the AI model that randomizing a certain element does not meaningfully change the output and/or outcome). After the adjusted resource exchange ecosystem is updated with the new randomized elements, the next iteration of the simulation may be run with the new settings and the results of the next iteration may be stored in the simulation result set. The process of randomly selecting elements of the resource exchange ecosystem to randomize, randomizing parameters associated with the randomly selected elements of the resource exchange ecosystem, and storing the outcome of that iteration in the simulation result set may be repeated until a condition is met. For example, the condition may be a number of iterations set by an operator or an AI model, until a confidence threshold is reached, until a certain outcome is reached one or more times, and/or the like.

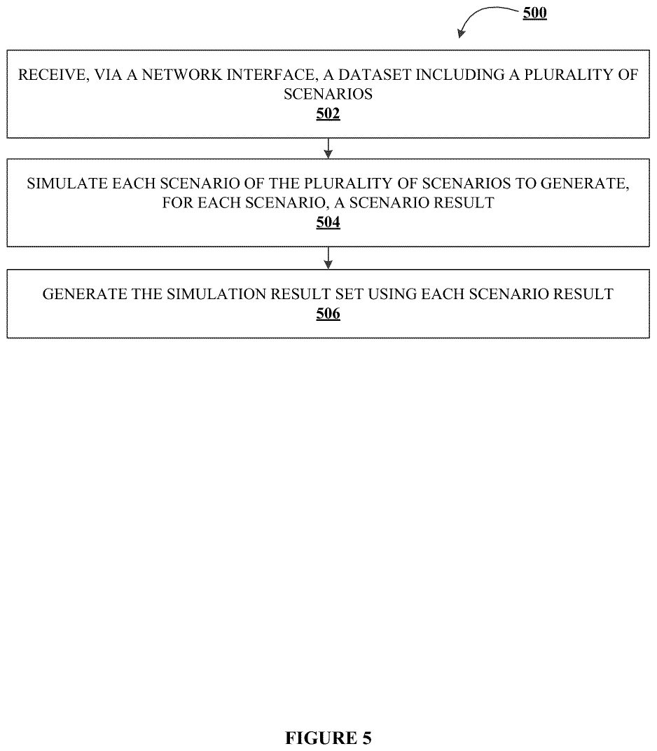

In some embodiments, the number of iterations and the randomly chosen elements with randomized values of the resource exchange simulation may be determined prior to the simulation of the first iteration. For example, a dataset of scenarios (e.g., randomized iterations) may be generated, prior to the simulation, by an AI model similar to the process flow 500 as described and shown herein with respect to FIG. 5.

In some embodiments, and as shown in block 410, the process flow 400 may include the step of generating an expected outcome using the simulation result set. In such embodiments, the simulation result set may include a plurality of entries each associated with an outcome of an iteration of the simulation. Additionally, or alternatively, each entry may include data associated with iteration specific details. In some embodiments, a model (e.g., an AI model) may be configured to ingest the simulation result and generate the expected outcome (e.g., the outcome with the highest probability of occurrence). For example, when a model ingests the simulation result set, data of the simulation result set may be preprocessed (e.g., cleaning, normalizing, and/or the like) to make the data suitable for analysis. Further, the model may conduct exploratory data analysis to generate summary statistics, visualize patterns, identify relationships between variables and/or outcomes, and/or the like. The model may then use statistical models, machine learning algorithms, computational techniques, and/or the like to analyze the data. This may include fitting probability distributions to estimate the likelihood of different outcomes, using regression models and/or classification models to explore relationships between inputs and results, and/or the like. The model may then generate a summary of the data of the simulation result set that may include descriptive statistics, key insights, a probabilistic summary of the outcomes, and/or the like. Additionally, or alternatively, to determine the most probable outcome, the model may use methods like maximum likelihood estimation, the mode of the distribution, and/or the like. Finally, the model may generate the expected outcome that may include the most probable outcome associated with the simulation input set and, in some embodiments, may further include decision recommendations, visualizations such as probability distributions or decision recommendations, and/or the like, to guide further analysis or decision-making.

In some embodiments, and as shown in block 412, the process flow 400 may include the step of transmitting, via the network interface, the expected outcome. In such embodiments, upon conclusion of the simulation result set and generation of the expected outcome, the expected outcome may be transmitted for storage and/or further analysis.

The process flow 400 may include additional embodiments, such as any single embodiment or any combination of embodiments described herein. Although FIG. 4 shows example blocks of the process flow 400, in some embodiments, the process flow 400 may include additional blocks, fewer blocks, different blocks, or differently arranged blocks than those depicted in FIG. 4. Additionally, or alternatively, two or more of the blocks of the process flow 400 may be performed in parallel. In some embodiments, the steps of the process flow 400 may be performed for a plurality of users simultaneously and/or at different times.

FIG. 5 illustrates another process flow 500 for stochastic simulation of source responses to inputs in a resource exchange ecosystem, in accordance with an embodiment of the invention. In some embodiments, a system (e.g., similar to one or more of the systems shown and described herein with respect to FIGS. 1A-1C) may perform one or more of the steps of process flow 500. For example, a system for stochastic simulation of source responses to inputs in a resource exchange ecosystem (e.g., similar to the system 130 shown and described herein with respect to FIG. 1A-1C) may perform one or more of the steps of process flow 500. In some embodiments, an artificial intelligence engine (e.g., similar to the AI engine subsystem 200 as shown and described herein with respect to FIG. 2) may perform one or more of the steps of process flow 500. Additionally, or alternatively, a generative artificial intelligence engine (e.g., similar to the generative AI subsystem 300 as shown and described herein with respect to FIG. 3) may perform one or more of the steps of process flow 500.

In some embodiments, and as shown in block 502, the process flow 500 may include the step of receiving, via a network interface, a dataset including a plurality of scenarios. In such embodiments, an AI model may be configured to generate the dataset including the plurality of scenarios by randomly selecting one or more simulation elements of the resource exchange ecosystem, randomly generating one or more inputs to the one or more simulation elements (e.g., adjustments to one or more parameters associated with the one or more simulation elements), and/or generating a scenario including the one or more randomly selected simulation elements including the randomly generated one or more inputs. In this way, the dataset may be used by a simulation (e.g., similar to the simulations of the process flow 400 as shown and described herein with respect to FIG. 4) to include a plurality of randomized scenarios to iterate over and generate outcomes for. In some embodiments, the step of the block 502 of the process flow 500 may be performed in conjunction with the step of block 408 of the process flow 400.

In some embodiments, and as shown in block 504, the process flow 500 may include the step of simulating each scenario of the plurality of scenarios to generate, for each scenario, a scenario result. In such embodiments, the simulation of the scenario may generate an outcome of the conditions of that scenario as the scenario result. Further, the scenario result may include data directed to the probability of various micro scale outcomes and/or macro scale outcomes based on a simulation input set associated with the dataset of the plurality of scenarios. For example, an entity of a resource exchange ecosystem may input a new resource associated product into the resource exchange ecosystem and the simulation may be configured to predict how one or more additional entities may respond to the introduction of the new resource associated product and/or how a plurality of users may respond to the new resource associated product. In such embodiments, a randomly chosen simulation element may include an occurrence of a political event with randomly chosen outcomes, environmental occurrence with a high threat level, and/or any other potential element in a resource exchange ecosystem. Further, a macro scale outcome, in such embodiments, may include the response of one or more additional entities, the overall sentiment towards the new resource associated product, and/or the like. Additionally, or alternatively, a micro scale outcome may include how individual resource accounts respond to the introduction of the new resource associated product, one or more user responses to the resource associated product, and/or the like. In some embodiments, the scenario result may include data directed to time evolution of a simulation element of the resource exchange ecosystem over a period of time (e.g., how an average resource account of a user may fluctuate over the period of time).

In some embodiments, and as shown in block 506, the process flow 500 may include the step of generating the simulation result set using each scenario result. In such embodiments, each scenario result may be the outcome of an iteration of the simulation of the resource exchange ecosystem using a scenario from the dataset. Each scenario result may be stored, in some embodiments, in the simulation result set. Additionally, or alternatively, each scenario result stored in the simulation result set may include data associated with each scenario (e.g., the one or more simulation elements that were randomly selected and randomized). In some embodiments, the step of block 506 of the process flow 500 may be performed prior to the step of block 410 of the process flow 400 as shown and described herein with respect to FIG. 4.

The process flow 500 may include additional embodiments, such as any single embodiment or any combination of embodiments described herein. Although FIG. 5 shows example blocks of the process flow 500, in some embodiments, the process flow 500 may include additional blocks, fewer blocks, different blocks, or differently arranged blocks than those depicted in FIG. 5.

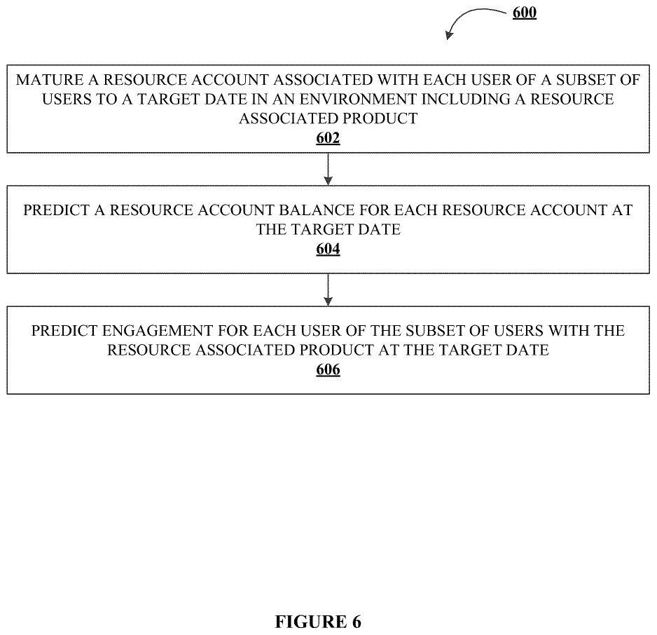

FIG. 6 illustrates another process flow 600 for stochastic simulation of source responses to inputs in a resource exchange ecosystem, in accordance with an embodiment of the invention. In some embodiments, a system (e.g., similar to one or more of the systems shown and described herein with respect to FIGS. 1A-1C) may perform one or more of the steps of process flow 600. For example, a system for stochastic simulation of source responses to inputs in a resource exchange ecosystem (e.g., similar to the system 130 shown and described herein with respect to FIG. 1A-1C) may perform one or more of the steps of process flow 600. In some embodiments, an artificial intelligence engine (e.g., similar to the AI engine subsystem 200 as shown and described herein with respect to FIG. 2) may perform one or more of the steps of process flow 600. Additionally, or alternatively, a generative artificial intelligence engine (e.g., similar to the generative AI subsystem 300 as shown and described herein with respect to FIG. 3) may perform one or more of the steps of process flow 600.

In some embodiments, and as shown in block 602, the process flow 600 may include the step of maturing a resource account associated with each user of a subset of users to a target date in an environment including a resource associated product. In such embodiments, the subset of users of a plurality of users of an entity of a plurality of entities may each be associated with a resource account, where each resource account may be generated using an average resource balance and a standard deviation of the average resource balance, and where the average resource balance may be generated via data of another subset of users of the plurality of users of the entity. In this way, additional users and/or resource accounts associated with the additional users may be generated to include in simulations of various simulations input sets. In some embodiments, a simulation may be directed to modeling the time evolution of one or more parameters of a resource exchange environment such as resource accounts. As such, a simulation input set may include the target date and the resource associated product and may generate an outcome that includes data for one or more resource accounts associated with one or more users at the target data in the context of the resource associated product. In this way, embodiments of the present disclosure may predict how user accounts may adjust over time with the introduction of a new resource associated product and/or in the context of other random elements or situations. In some embodiments, the step of block 602 of the process flow 600 may be performed in conjunction with the step of block 408 as shown and described herein with respect to FIG. 4.

In some embodiments, and as shown in block 604, the process flow 600 may include the step of predicting a resource account balance for each resource account at the target date. In such embodiments, a simulation may include a plurality of iterations with each iteration associated with randomly selected and randomized simulation elements. Additionally, or alternatively, the outcome of each iteration may be used to generate a simulation result set which may then be analyzed to generate an expected outcome. Further, the expected outcome may include data directed to a prediction and/or probabilities of resource account balances for each resource account at the target date (e.g., similar to one or more steps of the process flow 400 as shown and described herein with respect to FIG. 4).

In some embodiments, and as shown in block 606, the process flow 600 may include the step of predicting engagement for each user of the subset of users with the resource associated product at the target date. Using the predicted resource account balances, the engagement of users associated with the predicted resource account balances with the resource associated product may be generated. For example, how a user engages with a resource associated product may be predicated on, fully or in-part, on a resource balance on a resource account of theirs. In this way, using the steps of the process flow 600, new sets of users each of which may be associated with a resource account may be generated for use in simulations of adjusted resource exchange ecosystems. The resource balance of each account may be matured in a plurality of iterations to determine, on average, what the resource balance of each account may be and, based on the resource balance and/or any additional factors, the engagement of each user with a new resource associated product may be predicted. Further, using the individual user engagements with a new resource associated product, a measure of overall engagement with the new resource associated product may be generated.

The process flow 600 may include additional embodiments, such as any single embodiment or any combination of embodiments described herein. Although FIG. 6 shows example blocks of the process flow 600, in some embodiments, the process flow 600 may include additional blocks, fewer blocks, different blocks, or differently arranged blocks than those depicted in FIG. 6.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in party to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for stochastic simulation of source responses to inputs in a resource exchange ecosystem, the system comprising:
a network interface configured to communicate via a communication network;
at least one non-transitory storage device comprising computer program code stored thereon; and
at least one processing device operably coupled to the network interface, and the at least one non-transitory storage device, wherein the computer program code comprises computer instructions configured to cause the processing device to:
generate a simulation comprising a resource exchange ecosystem, wherein the resource exchange ecosystem comprises a plurality of entities, wherein each entity of the plurality of entities comprises a plurality of users and one or more decision makers;
receive, via the network interface, a simulation input set associated with the resource exchange ecosystem;
adjust the resource exchange ecosystem using the simulation input set;
execute the simulation with the adjusted resource exchange ecosystem to generate a simulation result set for the simulation input set;
generate an expected outcome using the simulation result set; and
transmit, via the network interface, the expected outcome.

2. The system of claim 1, wherein the at least one non-transitory storage device comprises computer-executable program code that, when executed by the at least one processing device, causes the at least one processing device to, when executing the simulation:
receive, via the network interface, a dataset comprising a plurality of scenarios;
simulate each scenario of the plurality of scenarios to generate, for each scenario, a scenario result; and
generate the simulation result set using each scenario result.

3. The system of claim 2, wherein the dataset comprising the plurality of scenarios is generated by an AI model configured to:
randomly select a simulation element of the resource exchange ecosystem;
randomly generate one or more inputs to the simulation element; and
generate a scenario comprising the simulation element comprising the generated one or more inputs.

4. The system of claim 1, wherein one or more users of each plurality of users is associated with one or more additional entities of the plurality of entities.

5. The system of claim 1, wherein a subset of users of a plurality of users of an entity of the plurality of entities is each associated with a resource account, wherein each resource account is generated using an average resource balance and a standard deviation of the average resource balance, and wherein the average resource balance is generated via data of another subset of users of the plurality of users of the entity.

6. The system of claim 5, wherein the simulation input set comprises a resource associated product and wherein the at least one non-transitory storage device comprises computer-executable program code that, when executed by the at least one processing device, causes the at least one processing device to, when executing the simulation:
mature the resource account associated with each user of the subset of users to a target date in an environment comprising the resource associated product;
predict a resource account balance for each resource account at the target date; and
predict engagement for each user of the subset of users with the resource associated product at the target date.

7. The system of claim 1, wherein the simulation input set comprises a resource associated product associated with a first entity of the plurality of entities, and wherein the expected outcome comprises a response resource associated product associated with a second entity of the plurality of entities.

8. The system of claim 1, wherein the simulation input set comprises a target date for the generated expected outcome, and wherein executing the simulation comprises modeling time evolution of one or more parameters associated with the resource exchange ecosystem.

9. A computer program product for stochastic simulation of source responses to inputs in a resource exchange ecosystem, the computer program product comprising a non-transitory computer-readable medium comprising code causing an apparatus to:
generate a simulation comprising a resource exchange ecosystem, wherein the resource exchange ecosystem comprises a plurality of entities, wherein each entity of the plurality of entities comprises a plurality of users and one or more decision makers;
receive, via a network interface, a simulation input set associated with the resource exchange ecosystem;
adjust the resource exchange ecosystem using the simulation input set;
execute the simulation with the adjusted resource exchange ecosystem to generate a simulation result set for the simulation input set;
generate an expected outcome using the simulation result set; and
transmit, via the network interface, the expected outcome.

10. The computer program product of claim 9, wherein the non-transitory computer-readable medium comprises code causing an apparatus to, when executing the simulation:
receive, via the network interface, a dataset comprising a plurality of scenarios;
simulate each scenario of the plurality of scenarios to generate, for each scenario, a scenario result; and
generate the simulation result set using each scenario result.

11. The computer program product of claim 10, wherein the dataset comprising the plurality of scenarios is generated by an AI model configured to:
randomly select a simulation element of the resource exchange ecosystem;
randomly generate one or more inputs to the simulation element; and
generate a scenario comprising the simulation element comprising the generated one or more inputs.

12. The computer program product of claim 9, wherein one or more users of each plurality of users is associated with one or more additional entities of the plurality of entities.

13. The computer program product of claim 9, wherein a subset of users of a plurality of users of an entity of the plurality of entities is each associated with a resource account, wherein each resource account is generated using an average resource balance and a standard deviation of the average resource balance, and wherein the average resource balance is generated via data of another subset of users of the plurality of users of the entity.

14. The computer program product of claim 13, wherein the simulation input set comprises a resource associated product and the non-transitory computer-readable medium comprises code causing an apparatus to, when executing the simulation:
mature the resource account associated with each user of the subset of users to a target date in an environment comprising the resource associated product;
predict a resource account balance for each resource account at the target date; and
predict engagement for each user of the subset of users with the resource associated product at the target date.

15. The computer program product of claim 9, wherein the simulation input set comprises a resource associated product associated with a first entity of the plurality of entities, and wherein the expected outcome comprises a response resource associated product associated with a second entity of the plurality of entities.

16. The computer program product of claim 9, wherein the simulation input set comprises a target date for the generated expected outcome, and wherein executing the simulation comprises modeling time evolution of one or more parameters associated with the resource exchange ecosystem.

17. A computer-implemented method for stochastic simulation of source responses to inputs in a resource exchange ecosystem, the method comprising:
generating a simulation comprising a resource exchange ecosystem, wherein the resource exchange ecosystem comprises a plurality of entities, wherein each entity of the plurality of entities comprises a plurality of users and one or more decision makers;
receiving, via a network interface, a simulation input set associated with the resource exchange ecosystem;
adjusting the resource exchange ecosystem using the simulation input set;
executing the simulation with the adjusted resource exchange ecosystem to generate a simulation result set for the simulation input set;
generating an expected outcome using the simulation result set; and
transmitting, via the network interface, the expected outcome.

18. The method of claim 17, the method further comprising, when executing the simulation:
receiving, via the network interface, a dataset comprising a plurality of scenarios;
simulating each scenario of the plurality of scenarios to generate, for each scenario, a scenario result; and
generating the simulation result set using each scenario result.

19. The method of claim 18, wherein the dataset comprising the plurality of scenarios is generated by an AI model configured for:
randomly selecting a simulation element of the resource exchange ecosystem;
randomly generating one or more inputs to the simulation element; and
generating a scenario comprising the simulation element comprising the generated one or more inputs.

20. The method of claim 17, wherein one or more users of each plurality of users is associated with one or more additional entities of the plurality of entities.
